(19) United States
(12) Patent Application Publication
(10) Pub. No.: US 2005/0275371 A1
(43) Pub. Date: Dec. 15, 2005

(54) Current monitor

(76) Inventor: Shamel A. Bersiek, Laguna Hills, CA (US)

Correspondence Address: STOUT, UXA, BUYAN & MULLINS LLP, 4 VENTURE, SUITE 300, IRVINE, CA, 92618, US

(21) Appl. No.: 11/154,382

(22) Filed: Jun. 15, 2005

Related U.S. Application Data
(60) Provisional application No. 60/580,067, filed on Jun. 15, 2004.

(51) Int. Cl. H02J 7/02

(52) U.S. Cl. 320/111

(57) ABSTRACT

Power monitoring devices and systems structured to be removably connected between a multiple outlet power strip and a power source and effective to provide real-time monitoring of voltage and/or current flowing through the power strip, are provided. The devices include a housing, a receptacle located on a first end of the housing and suitable for receiving a plug of a power strip, and a set of prongs located on a second end and suitable for connecting the device to an electrical outlet. Monitoring devices useful for detecting failure of a battery in a string of batteries utilized in a UPS or like system are also provided.

### RELATED APPLICATION

This application claims the benefit of U.S. Provisional Application No. 60/580,067, filed Jun. 15, 2004, the entire disclosure of which is incorporated herein by this reference.

### BACKGROUND OF THE INVENTION

The present invention generally relates to devices for monitoring electrical power, and more specifically relates to devices for monitoring power consumption of electrical equipment and battery failure detection monitors.

Electrical equipment such as home appliances, multimedia equipment, computers and computer accessories and the like, all differ widely in terms of the amount of electricity consumed thereby. Thus, the cost of operating such equipment also varies widely. However, in most cases, the amount of electricity consumed by an appliance is not readily apparent. It would be useful if a consumer had means at his disposal by which electric power consumption could be monitored, in which case a consumer could take steps to use higher power consumption devices more sparingly in order to save costs and/or to prevent overloaded circuits.

There is an increasing popularity in the use of home offices equipped with high energy demanding electrical equipment such as computers, printers, facsimile machines, and the like. Unfortunately, electrical systems in some homes, particularly older homes, are not capable of supporting the electrical load demanded by such equipment, and are therefore at increased risk of overheating due to circuit overload.

Uninterruptible power supplies (UPSs), inverters, and like devices, are connectable to a primary power supply and contain a secondary power supply, for example a battery string, that provides back-up power to equipment in the event the primary power supply should suddenly fail. Typically, if there is a failure of the primary power supply, the secondary power supply will be effective to provide uninterrupted power to the equipment, for example, such that the equipment can be shut down in a safe and orderly fashion.

There remains a need for consumer-friendly, safe, inexpensive power monitors, for example, current and/or voltage monitors, which readily provide continuous, real-time monitoring of power consumption of electrical appliances and other equipment, for example, aggregate power consumption of electrical appliances and other equipment, including such equipment connected to a multiple outlet power strip.

### SUMMARY OF THE INVENTION

The present invention provides convenient systems and apparatus for monitoring power consumption of electrical equipment, for example, in the form of current and/or voltage monitoring of equipment, for example, in real-time.

In a broad aspect, a power monitoring apparatus are provided, the apparatus being structured to be removably connected between a multiple outlet power strip and a power source. More particularly, the power monitoring apparatus comprises a receptacle suitable for receiving a plug of the power strip, and a set of prongs suitable for connecting the apparatus to an electrical socket.

In some embodiments, the power monitoring apparatus comprises a housing having a first end and a second end. The apparatus includes a receptacle, located on said first end of the housing and suitable for receiving a plug, for example a conventional three prong plug, of an electrical device. The apparatus further includes a set of prongs, located on the second end of the housing and suitable for connecting the apparatus to an electrical outlet, for example, a conventional wall socket.

The apparatus further includes a circuit, located within the housing, structured to monitor electric current flowing between the apparatus receptacle and the apparatus set of prongs when the apparatus is connected between an electrical device and an electric power source. Preferably, the housing, receptacle, and set of prongs are configured such that the receptacle and the set of prongs are in linear alignment with one another.

Advantageously, the power monitoring apparatus is useful for monitoring a characteristic of electric current, for example, at least one of current and voltage, flowing from the power source into the power strip when the apparatus is electrically connected therebetween. Preferably, the power monitoring apparatus includes a display for displaying and/or conveying information about the electric current, for example, real-time current and/or real-time voltage flowing into the power strip.

For example, the display may comprise at least one of an alarm (e.g. a visual, audible, tactile, or other alarm), a real-time current reading (e.g. a digital current reading), and a real-time voltage reading (e.g. a digital voltage reading). In a preferred embodiment, the power monitoring apparatus includes a display comprising an alarm and at least one of a real-time current reading and a real-time voltage reading.

In a preferred embodiment, the apparatus includes substantially no digital storage capability structure, for example, substantially no structure effective to store data relating to the electric current and/or voltage moving through the circuit.

In another aspect of the invention, battery failure detection monitors are provided, generally for use with a device having a string of batteries, such as an uninterruptible power supply (UPS), inverter or the like. In many facilities, inverters and UPS systems utilize battery power to provide continuous power to the load in absence of primary power. A string of batteries in the device are usually charged by a rectifier/charger unit. The battery monitors of the invention are useful for indicating when a battery in the string has failed or is beginning to fail.

Battery monitors of the invention are effective to detect failure and/or impending failure of a battery string, in order to prevent complete power failure to equipment attached to the UPS, inverter or the like in the absence of primary power. Advantageously, the present device is useful during a normal charging of the battery string, and/or while the device is on-line.

For example, in one embodiment, the battery monitor in accordance with the invention is comprised of an AC current transformer (“CT”) that is monitored by electronic circuit that will detect current status as it reaches zero then will produce an alarm in a visual, audible and/or auxiliary contact. In addition, the battery monitor may be structured to detect the total millivolts across the total string of batteries and will alarm if the reading reaches a certain predetermined low level.

These and other aspects of the present invention are apparent in the following detailed description and claims, particularly when considered in conjunction with the accompanying drawings in which like parts bear like reference numerals.

### BRIEF DESCRIPTION OF THE DRAWINGS

FIG. 1 is a perspective and diagrammatical view of a system in accordance with the present invention, including a current monitor apparatus in accordance with the invention and a power strip.

FIG. 2 is a perspective and diagrammatical view of the system shown in FIG. 1, arranged in a different manner to illustrate versatility of this embodiment of the invention.

FIG. 3 is a somewhat schematic representation of a current monitor in accordance with the present invention.

FIG. 4 is a circuit diagram useful in embodiments of the present invention.

FIG. 5 is a perspective view of a current monitor in accordance with a further embodiment of the invention.

FIG. 6 is a perspective view of a current monitor in accordance with yet a further embodiment of the invention.

FIG. 7 is a simplified schematic representation of a battery failure detection device in accordance with the present invention.

### DETAILED DESCRIPTION

Accordingly, the present invention provides a convenient, inexpensive system for monitoring power, for example, a system for monitoring at least one of current and voltage consumption of one or more appliances or other items of electrical equipment.

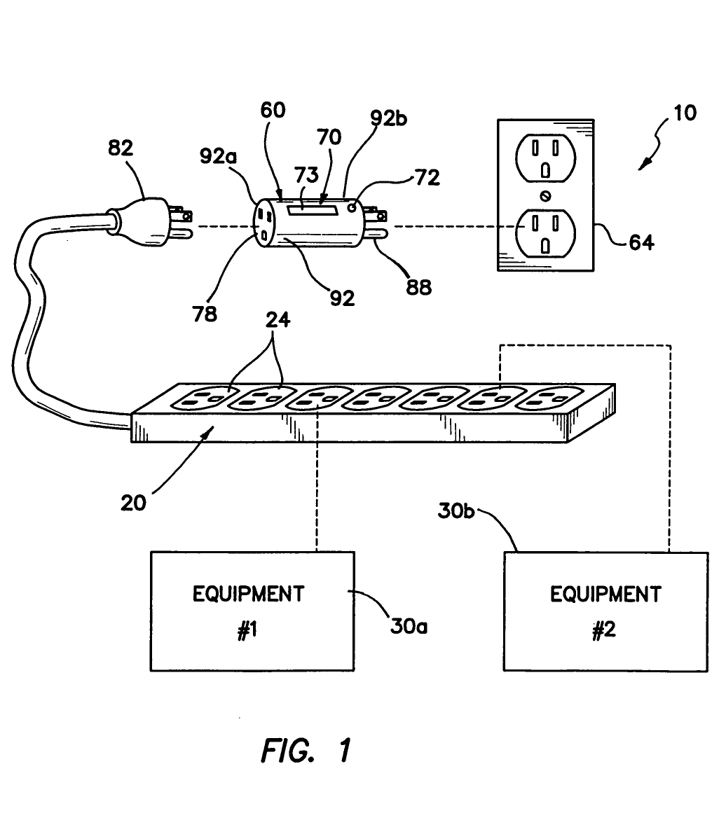

Turning now to FIG. 1, an embodiment of the invention is shown generally at 10 which comprises, in combination, a power strip 20 including multiple electrical sockets 24 suitable for connecting the power strip 20 to multiple electrical devices 30a, 30b, and a power monitoring apparatus 60, structured to be removably connected between a power source 64 and the power strip 20. The power monitoring apparatus 60 is structured and adapted to be useful for monitoring at least one characteristic of electric current flowing from the electrical source 64 when the power monitoring apparatus 64 is electrically connected between the power source 64 and the power strip 20.

In some embodiments of the invention, the power monitoring apparatus 60 includes a display 70 for displaying information about the electric current being drawn from the power source 64. The display 70 may comprise at least one of an alarm 72, for example a visual, audible, tactile or other alarm, a real-time current reading, and/or a real-time voltage reading. The one or more readings may be provided by a LED screen 73, or other display, showing digital numerals indicating real-time current and/or real-time voltage in standard units of measurement.

In some embodiments of the invention, the display 70 consists essentially of at least two of an alarm, a real-time current reading and a real-time voltage reading. In some embodiments of the invention, the apparatus 60 has or includes no added data storage capability. In other words, the apparatus 60 may include no memory capability and/or may be structured so as to not be capable of collecting and/or storing data and/or information regarding electric current and/or voltage.

In the embodiment shown, the power monitoring apparatus 60 comprises a receptacle 78 suitable for receiving a plug 82, for example a standard, three-pronged plug, of an electrical device, and a set of prongs 88 suitable for connecting to an electrical socket, for example, a standard wall socket. The apparatus 60 further comprises a housing 92 containing circuitry effective in monitoring electrical flow between the receptacle 78 and the set of prongs 88 when the apparatus 60 is connected to, for example, between, a power source and an electrically operable device. In this embodiment of the invention, the receptacle 78 and the set of prongs 60 are disposed in linear alignment with one another such as shown. Further, in this embodiment, the apparatus 60 includes substantially no external electrically couplable wires and/or cords.

The housing 92 may be substantially cylindrical in shape and generally includes a first end 92a and a second end 92b. The receptacle 78 is located on the first end 92a, and the set of prongs 88 is located on, and extends directly from, the second end 92b. The housing 92, receptacle 78, and set of prongs 88 are preferably configured such that the receptacle 78 and the set of prongs 88 are in linear alignment with one another. Preferably, at least one of the set of prongs 88 and the receptacle 78 are disposed within the housing 92.

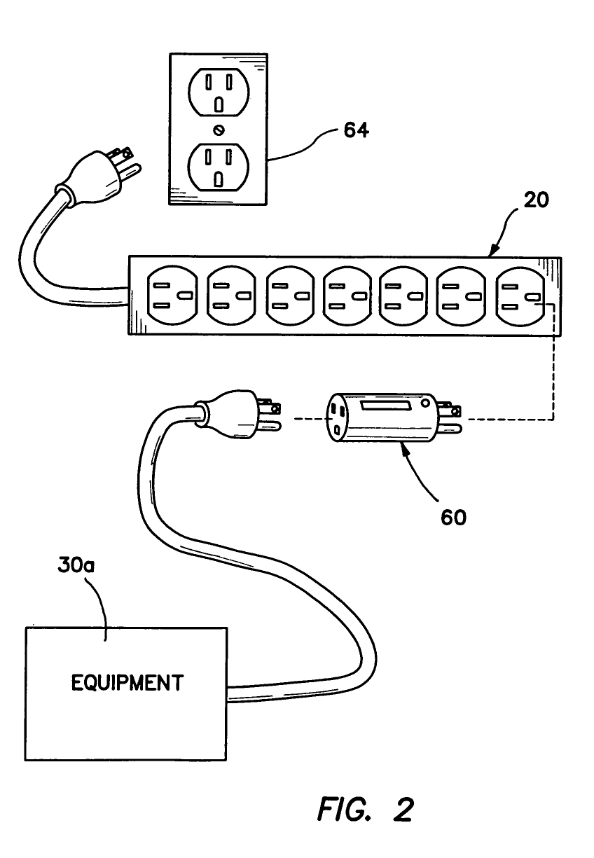

FIG. 2 shows another way of arranging apparatus 60 to measure or monitor current and/or voltage being drawn from a power source 64 to a piece of equipment 30a connected to power strip 20.

To determine the amount of power consumed by a single appliance, for example, equipment 30a shown in FIG. 2, or by a plurality of appliances connected to a common power strip 20, for example, equipment 30a and 30b shown in FIG. 1, the current monitor 60 makes use of the fact that an alternating current in a wire generates a proportional magnetic field, and vice versa. Since the line voltage is known for the application at a particular location, the power may be calculated from the amount of current supplied to the appliance.

The compact, relatively simple design of the present apparatus 60 makes the apparatus 60 especially useful for obtaining a quick, reliable indication of an amount of power being drawn from a wall outlet or other power source into one or more pieces of electrical equipment or appliances.

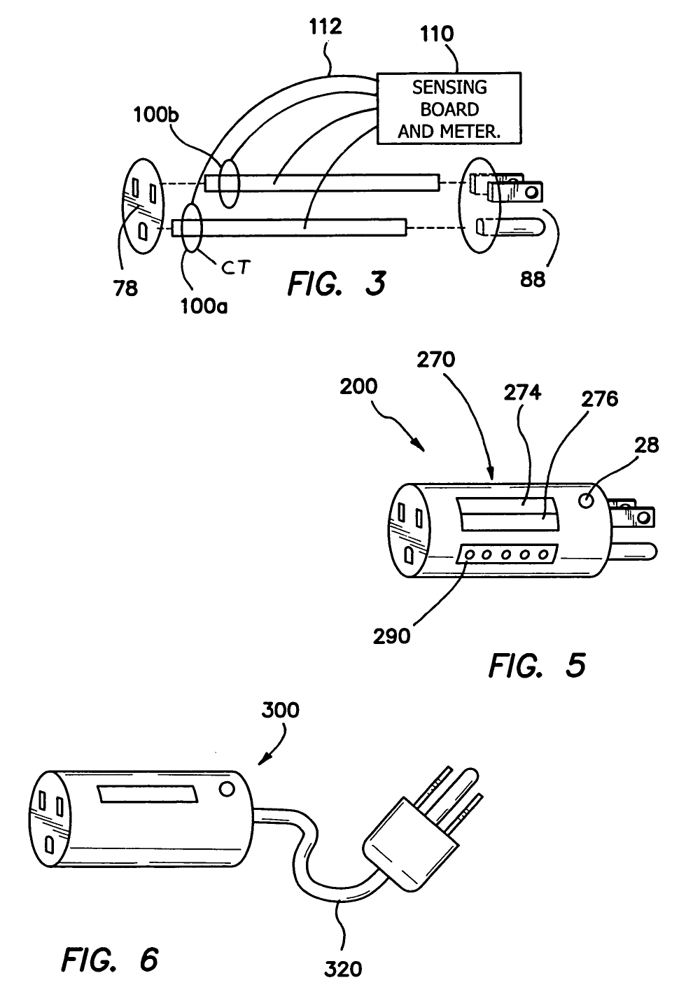

FIG. 3 shows a simplified circuit diagram of the in-line current monitor 60 in accordance with an embodiment of the invention. The circuit includes current transformers 100a, 100b connected between the receptacle 78 and the set of prongs 88, and to a sensing board 110, by means of sensing wires 112.

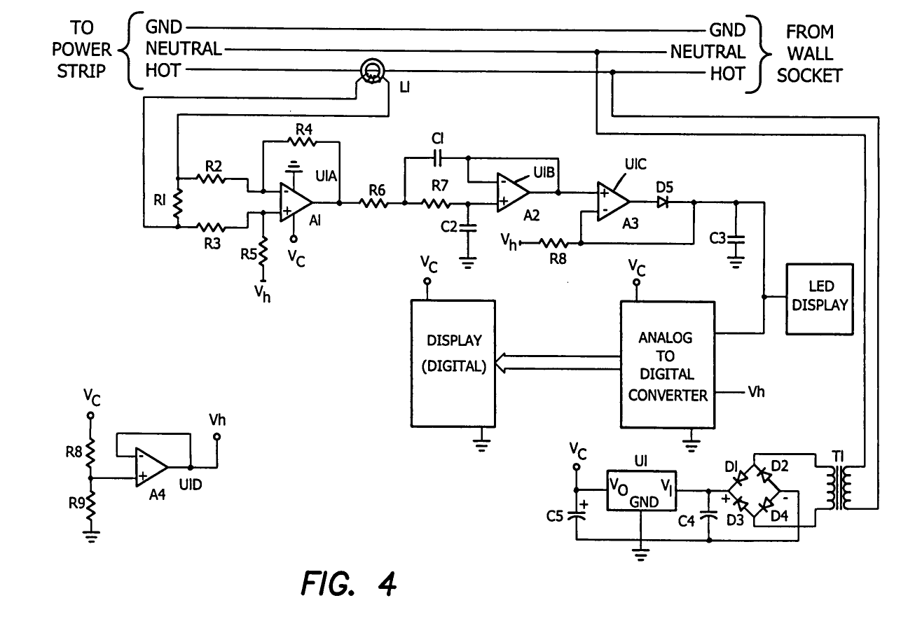

Referring to the schematic in FIG. 4, another suitable circuit is shown. L1 is a coil which is wound around a toroid. The conductor for the live connection of the equipment/power strip passes through the center of the toroid. An alternating current passing through the live conductor will create a proportional magnetic field in the toroid, which will in turn induce a proportional alternating current through L1. This current provides an alternating signal across resistor R1. The voltage is then amplified with reference to Vh which is half the supply voltage Vc. Reference voltage Vh is formed by the resistors R8 and R9, and is buffered by the operational amplifier A4. The high gain differential amplifier is composed of operational amplifier A1 and resistors R2, R3, R4 and R5. After amplification, the signal is put through a low pass filter to eliminate any transients. The low pass filter is made up of operational amplifier A2, resistors R6, R7 and capacitors C1 and C2. The final step in processing the signal is performed by operational amplifier A3 which in conjunction with diode D5, resistor R8 and capacitor C3 rectify the alternating signal with reference to voltage Vh. The capacitor C3 is used to hold a DC level which is equal to the peak AC level. This DC voltage level is input to an analog to digital converter which provides a digital representation of the analog voltage to the display.

FIGS. 5 and 6 show other embodiments of the invention.

FIG. 5 shows an apparatus 200 having a display 270 including a current monitor 274 which shows real-time current, and a voltage monitor 276 which shows real-time voltage passing through the apparatus 200. An LED 280 may also be provided for signaling circuit overload. A series of multicolored LEDs 290 may be provided for signaling when certain levels of power draw have been reached. It will be appreciated by those of skill in the art that appropriate modifications to the internal circuitry of the apparatus may be made as necessary or desirable to provide the desired display characteristics. Such modifications will be well known and understood by those of skill in the art and are thus not described in great detain herein.

FIG. 6 shows an apparatus 300 in accordance with the invention including a cord 320 for enhancing versatility of the apparatus 300.

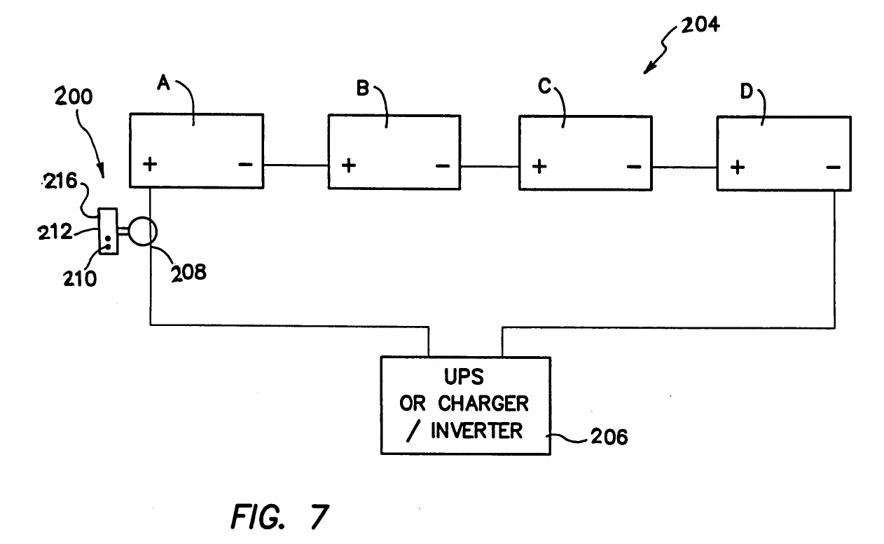

Turning now to FIG. 7, the present invention further provides a battery failure detection monitor (hereinafter sometimes “battery monitor”), shown in schematic form generally at 200. In many facilities, inverters and UPS systems utilize battery power to provide continuous power to a load in absence of primary power. The batteries are usually charged by a rectifier/charger unit. The present battery monitor 200 is designed to detect failure of a battery, for example, battery B, present within a string 104 of batteries A, B, C, and D, for example, while the string 104 of batteries is on-line and/or being charged.

Such a string 204 of batteries may be present to support an inverter in a conventional uninterruptible power supply device (UPS device) 206, or other piece of equipment commonly having a string of batteries. The battery monitor 200 includes a coupling mechanism suitable for coupling the battery monitor 200 to the device 206 at a point of contact 108 by suitable means. The battery monitor 200 further comprises an indicator 210, for example, a suitable audible, visual indicator and/or in auxiliary contact 216, which operates to provide an alert of battery failure, for example, while the batteries are on-line and/or being charged.

Preferably, the battery monitor 200 of the present invention comprises an AC current transformer (“CT”) that is coupled to and monitored by an electronic sensing circuit 212 that is configured to detect current status as the current status approaches zero. The electronic sensing circuit 212 is effective to send a signal to the indicator 210 which produces an alarm. In some embodiments, the battery monitor 200 is configured to detect the total millivolts across the total string of batteries and will alarm if the reading exceeds a predetermined set level.

For example, in one aspect of the invention, the current transformer and positive and negative sensing wires may be coupled to the battery string at a suitable point therealong. Alarm contact points, in normally closed or normally open states, change states once a battery failure has been detected, thereby sending an alert signal to the indicator.

The electronic sensing circuit 212, coupled to the current transformer CT, is preferably configured or designed to detect the AC ripple current produced by the charger/rectifier and going through the batteries A, B, C, and D, and the AC millivolts (ripple voltage) across the total string of batteries. The point of ripple current monitoring could be at any suitable location along the string of the battery series. The absence of AC ripple current or high AC millivolts readings indicates a failed battery, as it will indicate a high internal impedance/resistance of the battery. As known to those of skill in the art, the electrical formula for this application is:
Volts (V)=Current (I)×Resistance (R).

If V is constant and R increases then I will decrease indicating a high resistance battery (defective) in the string. Further, if I is constant and R increases, then V will increase, also indicating a defective battery. The two readings of the ripple current and millivolts are monitored using battery monitor 100 for redundancy and accuracy.

For example, the battery monitor 200 may be configured to send an AC current through the string 204 of batteries at the point of contact 208, while the string 204 of batteries is being routinely charged. If a certain low level of current or high level of voltage is sensed, the indicator 210 of the battery monitor 200 will provide an audible, visible, or other auxiliary alarm, indicating that a battery within the string of batteries has failed.

The principle of the detection is generally based on the fact that the AC ripple current will pass though from the positive of the first battery A, to the positive of the next battery B and so on, until it reaches the end of the string. Defective batteries typically have high resistance/impedance, which will increase the millivolts readings, and also will prevent the AC ripple current produced by the charger/rectifier to pass through a low current reading or high AC millivolts reading is an indication of one or more defective batteries in the string.

In some embodiments, the inventive battery monitor 200 is designed to detect the absence of the charging ac ripple current that goes through a battery or battery string and the increase of the ripple voltage (usually in millivolts) and provide an alarm in a form of visual, audible, and/or an auxiliary contact (normally open or closed that switches states). The alarm is an indication that one or more batteries in the string have high impedance or is electrically open, indicating a defective battery which will result in a total string failure.

Each and every feature described herein, and each and every combination of two or more of such features, is included within the scope of the present invention provided that the features included in such a combination are not mutually inconsistent.

While this invention has been described with respect to various specific examples and embodiments, it is to be understood that the invention is not limited thereto and that it can be variously practiced within the scope of the following claims.

1. A system for monitoring power, the system comprising, in combination:
a power strip including a plurality of electrical sockets suitable for connecting the power strip to a plurality of electrical devices; and
a power monitoring apparatus, structured to be removably connected between a power source and a power strip;
the power monitoring apparatus being useful for monitoring a characteristic of electric current flowing from the power source and into the power strip when the power monitoring apparatus is electrically coupled between the power source and the power strip.

2. The system of claim 1 wherein the power monitoring apparatus is structured to monitor at least one of current and voltage.

3. The system of claim 1 wherein the power monitoring apparatus includes a display for displaying information about the electric current.

4. The system of claim 1 wherein the power monitoring apparatus includes a display comprising at least one of an alarm, a real-time current reading, and a real-time voltage reading.

5. The system of claim 1 wherein the power monitoring apparatus includes a display comprising at least two of an alarm, a real-time current reading, and a real-time voltage reading.

6. The system of claim 1 wherein the power monitoring apparatus comprises
a receptacle suitable for receiving a plug of an electrical device, and
a set of prongs suitable for connecting to an electrical socket,
wherein the receptacle and the set of prongs are in linear alignment with one another.

7. An apparatus for monitoring power, the apparatus comprising:
a housing having a first end and a second end;
a receptacle, located on said first end, suitable for receiving a plug of an electrical device;
a set of prongs, located on said second end, suitable for connecting to an electrical socket; and
a circuit, within said housing, structured to measure electric current flowing between said receptacle and said set of prongs when said apparatus is connected to a power source;
the housing, receptacle, and set of prongs being configured such that the receptacle and the set of prongs plug are in linear alignment with one another.

8. The apparatus of claim 7 further comprising a display effective to provide information about the electric current.

9. The apparatus of claim 8 wherein the display includes at least in of an alarm, a real-time current reading, and a real-time voltage reading.

10. The apparatus of claim 8 wherein the display includes at least two of an alarm, a real-time current reading, and a real-time voltage reading.

11. The apparatus of claim 6 including substantially no structure effective to store data relating to electric in the circuit.

12. A battery monitor for use with a device having a string of batteries, the monitor comprising:
a connector element structured to be electrically coupled to a string of batteries along a point of contact;
an electronic circuit structured to monitor current flow across the point of contact and to provide a signal when the current flow drops below a predetermined current level; and
an alarm, structured to receive the signal from the electronic circuit, the alarm being effective to produce an alarm in response to the signal.

13. The monitor of claim 13 wherein the circuit is effective to detect at least one of a reduction of a charging ac ripple current and an increase ripple voltage across the string of batteries.

14. The monitor of claim 13 wherein the circuit is effective to detect a reduction of a charging ac ripple current and an increase of ripple voltage across the string of batteries.

15. The monitor of claim 13 structured to be suitable for detecting failure or impending failure of a battery in a battery string in an uninterruptible power supply.

16. The monitor of claim 13 wherein the circuit is configured to detect an absence of a charging AC ripple current.
